(19) United States
(12) Patent Application Publication
(10) Pub. No.: US 2025/0390677 A1
(43) Pub. Date: Dec. 25, 2025

(54) SYSTEM AND METHODS FOR DOCUMENT PROCESSING FOR DATA EXTRACTION AND MATCHING

(71) Applicant: State Farm Mutual Automobile Insurance Company, Bloomington, IL (US)

(72) Inventors: Sateesh NALLAMOTHU, Normal, IL (US); Srinivas C. REDDY, Cumming, GA (US); Timothy HUSARIK, Normal, IL (US); Deana DOOLEY, Normal, IL (US); Bryan CARAWAY, Washington, DC (US); Musa MOHAMED, Atlanta, GA (US); Matthew SWINGLER, Normal, IL (US); James STEHLIK, Bloomington, IL (US)

(73) Assignee: State Farm Mutual Automobile Insurance Company, Bloomington, IL (US)

(21) Appl. No.: 18/753,279

(22) Filed: Jun. 25, 2024

(51) Int. Cl. G06F 40/279; G06V 30/12; G06V 30/148; G06V 30/19

(52) U.S. Cl. CPC G06F 40/279; G06V 30/133; G06V 30/153; G06V 30/19093

(57) ABSTRACT

System and methods are disclosed for matching extracted text data based on one or more similarity scores. The method may include receiving one or more documents from a plurality of data sources, utilizing an optical character recognition algorithm for extracting text data from the one or more documents, comparing, utilizing a fuzzy matching algorithm, the extracted text data to reference dataset(s) to determine one or more matches between the extracted text data and at least one of the reference dataset(s), wherein the one or more matches are based on at least one similarity score, inputting the determined one or more matches and the at least one similarity score into a trained machine-learning model to refine the one or more matches, and outputting a representation of the refined one or more matches and the at least one similarity score to a graphical user interface of a device.

### TECHNICAL FIELD

This present disclosure relates generally to the field of data processing. In particular, the present disclosure relates to document processing, text extraction, and text matching for establishing associations.

### BACKGROUND

Conventional methodologies for extracting and matching texts from documents face significant technical challenges. In one instance, the variability of document formats (e.g., scanned images, handwritten forms, and various electronic document formats) may present a set of complexities, such as poor image quality, skewed perspectives, inconsistent layouts, language structure variations, and font variations. In one example, scanned documents often suffer from poor image quality, skewing, and distortion, which may lead to errors in character recognition. In one example, handwritten forms may pose an additional challenge due to the variability in handwriting styles and legibility. In one example, electronic documents may feature inconsistent layouts, fonts, and encoding schemes, which may further complicate the extraction process. Extracting text accurately from such diverse formats may require sophisticated text processing techniques that can handle variations in text formats. Additionally, once the text is extracted, the process of matching texts (e.g., names) can be hindered by inconsistencies in formatting, misspellings, and variations in text representation across documents. In one example, misspellings and typographical errors may complicate the matching process, as slight deviations from the correct spellings may lead to mismatches. In one example, variations in name formats (e.g., abbreviations, nicknames, aliases, or initials) may introduce ambiguity and may increase the likelihood of false positives or negatives during the matching process. Such inconsistencies may make it challenging to establish uniform patterns for extracting and matching texts and may necessitate sophisticated algorithms capable of accommodating diverse text formats, detecting errors (e.g., misspellings), and resolving variations to achieve accurate and reliable association for extracted texts. As a result, a need exists for a process that accurately and efficiently performs text matching to establish associations between documents and users.

This disclosure is directed to addressing above-referenced challenges. The background description provided herein is for the purpose of generally presenting the context of the disclosure. Unless otherwise indicated herein, the materials described in this section are not admitted to be prior art, or suggestions of the prior art, by inclusion in this section.

### SUMMARY

The present embodiments may relate, inter alia, to solving one or more technical challenges, such as those discussed above and elsewhere herein. Specifically, the present computer systems and computer-implemented methods may solve technical challenges by integrating: (i) advanced optical character recognition (OCR) technology enhanced by natural language processing (NLP) techniques to standardize language variations and extract key entities from diverse formats, (ii) fuzzy matching algorithms enhanced by NLP techniques to account for variations in spelling and context for accurate matching, and (iii) machine-learning algorithms for improving OCR accuracy, enhancing fuzzy matching algorithms, or performing advanced analysis on document content.

In one aspect, a computer-implemented method may include receiving, by one or more processors, one or more documents from a plurality of data sources; extracting, by the one or more processors utilizing an optical character recognition algorithm, text data from the one or more documents; comparing, by the one or more processors utilizing a fuzzy matching algorithm, the extracted text data to a plurality of reference datasets to determine one or more matches between the extracted text data and at least one of the plurality of reference datasets, wherein the one or more matches are based on at least one similarity score; inputting, by the one or more processors, the determined one or more matches and the at least one similarity score into a trained machine-learning model to refine the one or more matches; and outputting, by the one or more processors, a representation of the refined one or more matches and the at least one similarity score to a graphical user interface of a device.

In another aspect, a system for one or more processors of a computing system; and at least one non-transitory computer readable medium storing instructions which, when executed by the one or more processors, may cause the one or more processors to perform operations including: receiving one or more documents from a plurality of data sources; extracting, utilizing an extraction technology, text data from the one or more documents; comparing, utilizing a matching algorithm, the extracted text data to a plurality of reference datasets to determine one or more matches between the extracted text data and at least one of the plurality of reference datasets, wherein the one or more matches are based on at least one similarity score; inputting the determined one or more matches and the at least one similarity score into a trained machine-learning model to validate a similarity assessment; and outputting a representation of the one or more matches and the at least one similarity score to a graphical user interface of a device.

In yet another aspect, a non-transitory computer readable medium storing instructions which, when executed by one or more processors of a computing system, cause the one or more processors to perform operations including: receiving one or more documents from a plurality of data sources; extracting, utilizing an optical character recognition algorithm, text data from the one or more documents; comparing, utilizing a fuzzy matching algorithm, the extracted text data to a plurality of reference datasets to determine one or more matches between the extracted text data and at least one of the plurality of reference datasets, wherein the one or more matches are based on at least one similarity score; inputting the determined one or more matches and the at least one similarity score into a trained machine-learning model to refine the one or more matches; and outputting a representation of the refined one or more matches and the at least one similarity score to a graphical user interface of a device.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 a diagram showing an exemplary computer system and/or computing environment for extracting texts and matching the extracted texts with relevant entities, according to certain aspects of the disclosure.

FIG. 2 depicts an exemplary flowchart of a computer-implemented or computer-based process for determining matches for extracted text data based on similarity score(s).

FIG. 3 depicts an exemplary training flow chart for one or more machine-learning models.

FIG. 4 illustrates an implementation of an exemplary computer system that executes techniques presented herein.

Advantages will become more apparent to those skilled in the art from the following description of the preferred embodiments, which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present embodiments may relate, inter alia, to computer systems and computer-implemented methods that may solve technical challenges by integrating: (i) advanced optical character recognition (OCR) technology enhanced by natural language processing (NLP) techniques to standardize language variations and extract key entities from diverse formats, (ii) fuzzy matching algorithms enhanced by NLP techniques to account for variations in spelling and context for accurate matching, and (iii) machine-learning algorithms for improving OCR accuracy, enhancing fuzzy matching algorithms, or performing advanced analysis on document contents.

Conventional methods may struggle to handle the wide array of document formats including scanned images, handwritten forms, portable document format (PDF), and electronic documents. The scanned images often suffer from poor image quality, including blurriness, skewing, and noise, which may degrade the accuracy of text extraction and recognition. Processing handwritten texts presents a significant challenge due to the variability in handwriting styles, legibility issues, and the absence of standardized conventions. The electronic documents may feature diverse layouts, fonts, and formatting styles, making it difficult for conventional methods to accurately extract structured information (e.g., names, addresses, and dates).

Conventional methods are technically challenged to handle variations in name formats (e.g., misspellings, abbreviations, and alternative spelling) leading to difficulties in accurately identifying and associating names with claim participants (e.g., insurance claim participants). In one example, the extracted texts may contain misspellings or typographical errors which may hinder accurate matching against a list of claim participants, especially when the errors are subtle or context-dependent. In one example, names may be represented differently across documents due to nicknames, aliases, maiden names, initials, or alternative spellings, making it challenging for conventional methods to establish consistent associations. In one example, ambiguous or noisy texts (e.g., abbreviations, acronyms, or special characters) may introduce uncertainty and confusion in the matching process, leading to incorrect associations and false positives. In one example, documents may include complex entity relationships, such as multiple individuals with similar names or entities with shared attributes, making it difficult for conventional methods to disambiguate and accurately match extracted text to the correct claim participant.

Conventional methods may face data sparsity and variability issues, for example, limited availability of training data or variability in the data distribution may affect the performance of conventional matching methods, particularly when dealing with unique names or when encountering data with imbalanced class distribution. Conventional methods may lack the ability to adapt to domain-specific knowledge, such as industry-specific terminology, naming conventions, or cultural differences, which may impact the accuracy and relevance of matching results. Furthermore, integrating conventional methods into existing workflows may pose challenges, such as interoperability issues, data format compatibility issues, or synchronization with external databases issues, affecting the seamless integration of matching capabilities into document processing pipelines. In addition, conventional methods are technically challenged to scale efficiently to handle large volumes of documents, leading to increased processing time, resource utilization, and operational costs.

### Exemplary Computer System

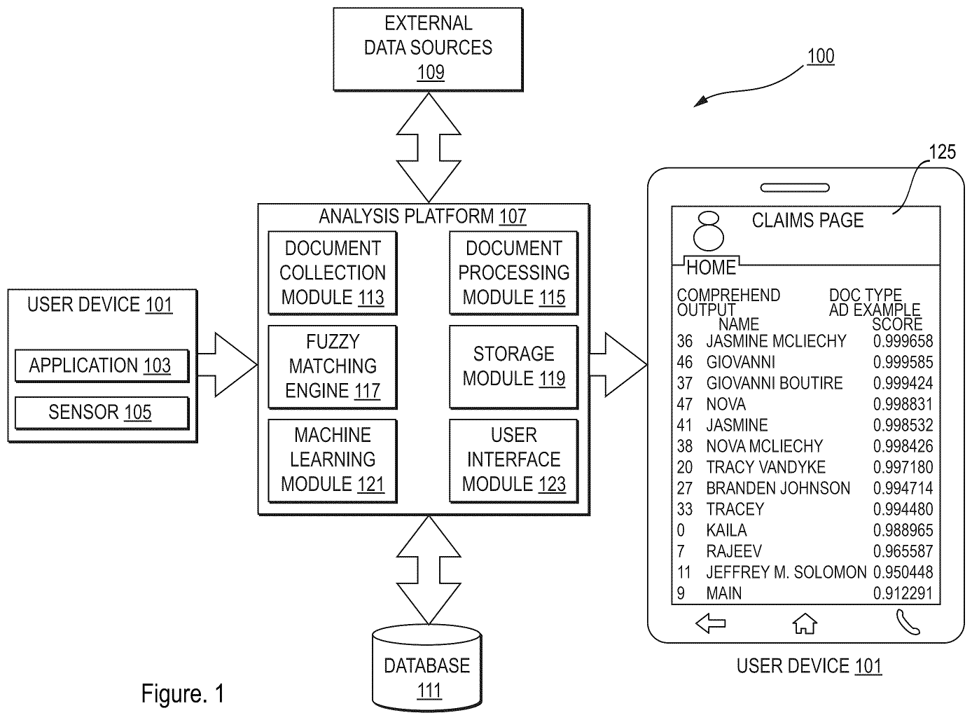

System 100 of FIG. 1 provides a comprehensive solution to the technical challenges faced by conventional methods in extracting data from documents. By integrating advanced OCR technology, machine-learning algorithms, and NLP techniques, the system 100 may facilitate the accurate and efficient extraction of text from diverse document formats. In one example, by leveraging deep learning models trained on large datasets, the system 100 may efficiently handle variations in layouts, font styles, and language structures, ensuring high accuracy in text extraction. In one example, the system 100 may incorporate context-aware processing and domain-specific knowledge bases for addressing the technical challenges related to name formatting, misspellings, and contextual ambiguity, and enabling precise identification and extraction of relevant information.

The system 100 may implement advanced machine-learning algorithms and intelligent matching techniques to overcome the technical challenges encountered by conventional methods while matching the extracted texts from the documents. In one example, the system 100 may incorporate fuzzy matching algorithms and probabilistic models to ensure robust and precise matching despite noise, inconsistencies, and complex entity relationships. In one example, the system 100 may leverage contextual understanding and semantic analysis to accurately identify and match extracted names to claim participants (e.g., insurance claim participants), overcoming issues relating to name variations and misspellings. Additionally, the system 100 may continuously learn from feedback and adapt to evolving data patterns, enhancing its matching capabilities over time and improving the accuracy and efficiency of document processing workflows.

FIG. 1 is a diagram showing an exemplary computer system for extracting texts and matching the extracted texts with relevant entities, according to certain aspects of the disclosure. FIG. 1 includes the computer system 100 that comprises a user device 101, an analysis platform 107, external data sources 109, and database 111. It should be understood that other implementations of system 100 may omit one or more of the foregoing components and/or may include additional components, as the case may be.

In one instance, the user device 101 may include but is not restricted to, any type of mobile terminal, wireless terminal, fixed terminal, or portable terminal. Examples of the user device 101 may include image input devices (e.g., scanners, cameras, etc.), hand-held computers, desktop computers, laptop computers, wireless communication devices, cell phones, smartphones, mobile communications devices, a Personal Communication System (PCS) device, tablets, server computers, gateway computers, or any electronic device capable of providing or rendering imaging data. In one example, the user device 101 may scan paper documents and create one or more digital images in pre-determined formats (e.g., Portable Document Format (PDF), Bit Map (BMP), Graphics Interchange Format (GIF), Joint Pictures Expert Group (“JPEG”), or any other formats). In one example, the user device 101 may generate a presentation of various user interfaces for the users to upload documents (e.g., claim documents) for processing. In one instance, the user device 101 may be configured with different features to enable generating, sharing, and viewing of visual content. Any known and future implementations of the user device 101 may be applicable.

In one instance, the user device 101 may include application 103. The application 103 may include, but is not restricted to, camera/imaging applications, content provisioning applications, software applications, networking applications, multimedia applications, media player applications, storage services, contextual information determination services, notification services, and the like. In one instance, application 103 may act as a client for the analysis platform 107 and may perform one or more functions associated with the functions of the analysis platform 107 by interacting with the analysis platform 107 over a communication network.

In one instance, the user device 101 may include sensor 105. The sensor 105 may include any type of sensor, for example, a network detection sensor for detecting wireless signals or receivers for different short-range communications (e.g., Bluetooth, Wi-Fi, Li-Fi, near field communication (NFC), etc. from a communication network), a camera/imaging sensor for gathering image data (e.g., images of claim records), an audio recorder for gathering audio data, and the like.

In one instance, various elements of the system 100 may communicate with each other through the communication network. The communication network may support a variety of different communication protocols and communication techniques. The communication network may allow the user device 101 to communicate with the analysis platform 107. The communication network may include one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

In one instance, the analysis platform 107 may be a platform with multiple interconnected components. The analysis platform 107 may include one or more servers, intelligent networking devices, computing devices, components, and corresponding software for extracting data from diverse document formats and matching the extracted information with relevant entities (e.g., claim participants).

The analysis platform 107 may utilize advanced OCR techniques for extracting text from documents in various formats (e.g., scanned images, PDFs, handwritten forms, etc.). By seamlessly integrating OCR capabilities into the document processing workflow, the analysis platform 107 may digitize the data, laying the foundation for further analysis and processing. Through meticulous pre-processing and analysis, the analysis platform 107 may identify textual content within documents. In one example, the analysis platform 107 may categorize documents into pre-determined categories or classes based on their content utilizing machine-learning models trained on labeled document datasets. The analysis platform 107 may utilize various techniques (e.g., pattern matching, rule-based extraction, or machine-learning approaches) for extracting specific types of information or entities (e.g., names, addresses, dates, etc.) from documents. In one example, the analysis platform 107 may employ sophisticated NLP algorithms to identify and extract names from the textual content. By analyzing linguistic patterns, context, and syntactic structures, the analysis platform 107 may discern the names of users mentioned in the text, ensuring comprehensive coverage and accuracy in name extraction.

The analysis platform 107 may utilize advanced fuzzy matching algorithms for comparing the extracted texts (e.g., names) with a list of claim participants. The analysis platform 107 may consider variations in name formatting, spelling, and contextual ambiguity for determining potential matches between extracted names and the claim participants. Through an iterative refinement and scoring mechanism, the fuzzy matching process may ensures precise and reliable associations, mitigating the impact of inconsistencies or errors in extracted texts. In one example, the fuzzy matching process (e.g., Levenshtein distance algorithm) may compute the distance between two strings by comparing the characters of the two strings and determining the minimum number of edits needed to make them identical. The Levenshtein distance algorithm may employ dynamic programming to efficiently compute the edit distance between two strings. Once the edit distance is calculated, a similarity score may be derived from the edit distance, and a threshold value may be applied to determine whether the similarity score indicates a match.

Upon successful matching, the analysis platform 107 may update the documents or records with associations between extracted text and claim participants. In one example, the analysis platform 107, via the OCR algorithm, may extract texts, such as “user A”, “MRI scan”, and “Jan. 10, 2024”, from a scanned medical bill submitted by the user. The analysis platform 107 may match, via the fuzzy matching algorithm, the extracted text with information in a reference database (e.g., the insurance company's database containing policyholder information and previous claims). The analysis platform 107 may compare “user A” against the policy holders database using similarity assessment (e.g., edit distance, token similarity, etc.) for identifying a match with a similarity score. Upon determining a match, the analysis platform 107 may update the claim records in the reference database with the matched association (e.g., user A″, “MRI scan”, and “Jan. 10, 2024”) including relevant identifiers and similarity scores. Each identified name within the document may be linked (e.g., annotations, metadata tags, embedded references, etc.) to the corresponding claim participant. These associations establish a direct connection between the extracted text and the claim participant they represent, facilitating easy retrieval and reference during subsequent processing stages. By maintaining accurate and up-to-date associations, the analysis platform 107 facilitates the efficiency and effectiveness of document processing workflows.

In one instance, the analysis platform 107 may comprise a document collection module 113, document processing module 115, a fuzzy matching engine 117, a storage module 119, a machine-learning module 121, and a user interface module 123, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one instance, the document collection module 113 may collect, e.g., in real-time or near real-time, relevant data (e.g., relevant documents) from a plurality of data sources (e.g., user device 101, external data sources 109) through various data collection techniques. The document collection module 113 may include various software applications (e.g., data mining applications in Extended Meta Language (XML)) that may automatically search for, and return, relevant data associated with the users. In one example, the document collection module 113 may use a web-crawling component to access the user device 101 and/or the plurality of data sources to collect the relevant data (e.g., documents, images of the documents). In some cases, the relevant data may reside in paper files that are scanned or entered into a digital format by a user or by an automated process (e.g., via a scanner). In one instance, the document collection module 113 may utilize clustering algorithms (e.g., K-means, hierarchical clustering, and topic modeling techniques) for grouping similar documents together based on their content, enabling the exploration and organization of large document collections.

In one instance, the document processing module 115 may extract data from documents in various formats. In one instance, the document processing module 115 may utilize an OCR algorithm for converting scanned images, PDFs, and handwritten forms into machine-readable text. In one example, the OCR algorithms may process images (e.g., images of claim documents) to convert them into editable texts (e.g., OCR′ed text). The OCR algorithms may provide a set of values describing a bounding box that uniquely specifies the region of the images containing the text segment. These bounding boxes may serve as essential markets for the OCR algorithms, allowing them to isolate and recognize text elements accurately. By segmenting the image into distinct regions corresponding to each character or word, the OCR algorithms may analyze the pixel data within these bounding boxes, identifying patterns and features indicative of textual content. This process may involve training sophisticated machine-learning models on vast datasets of annotated images, resulting in enabling the OCR algorithms to adapt and recognize text in various fonts, sizes, and orientations. This may ensure that textual content from diverse document sources is extracted accurately and efficiently. In one example, the document processing module 115 may utilize NLP algorithms for analyzing linguistic patterns, context, and syntactic structures, to discern the names of the users in the text for extraction. Furthermore, the document processing module 115 may incorporate pre-processing techniques to clean and enhance the extracted text, mitigating issues such as noise, skewing, and poor image quality. In one example, document processing module 115 may add metadata or tags to documents to facilitate the search and retrieval of the documents.

In one instance, the fuzzy matching engine 117 may facilitate accurate association of extracted text with relevant entities, such as claim participants. The fuzzy matching engine 117 may employ sophisticated algorithms to compare and measure the similarity between strings, accommodating variations in spelling, formatting, and context. The fuzzy matching engine 117 may compare the extracted name with the claim participant names in the list for calculating a similarity score for each comparison based on factors such as character similarity, string length, and positional weightings. In one example, the fuzzy matching engine 117 may utilize similarity metrics (e.g., the Levenshtein distance algorithm) which calculate the minimum number of edits (e.g., insertions, deletions, or substitutions) required to transform one string into another. The Levenshtein distance algorithm may employ dynamic programming to efficiently compute the edit distance between two strings. It may construct a matrix where each cell represents the edit distance between the substrings of the two strings. By recursively filling in the matrix based on previously computed values, the algorithm may determine the edit distance between the entire strings. Once the edit distance is calculated, a similarity score can be derived by transforming the edit distance into a normalized value. The fuzzy matching engine 117 may establish a threshold value to determine the minimum similarity score required for a match. The names with similarity scores above the threshold are considered potential matches. Once the match is confirmed, the fuzzy matching engine 117 may associate the extracted name with the relevant entities. By quantifying the degree of similarity between strings, the fuzzy matching engine 117 may identify potential matches even in the presence of misspellings, abbreviations, and typographical errors. The fuzzy matching engine 117 may incorporate additional features, such as phonetic matching, tokenization, and weighting schemes to further refine the matching process and improve accuracy.

Additionally, the fuzzy matching engine 117 may utilize NLP algorithms for analyzing the extracted text, identifying key entities, and extracting structured information such as names, dates, and addresses. In one instance, the NLP algorithms may utilize one or more language modeling techniques (e.g., statistical models, neural network models, rule-based models, syntactic models, etc.) to perform text classification, named entity recognition (NER), or syntactic parsing. By employing text classification, NER, or syntactic parsing, the NLP algorithms may discern key entities within the text, including names and other pertinent information. In one example, the fuzzy matching engine 117 may utilize NLP algorithms for computing semantic similarity scores between strings, and may assign higher scores to pairs of names that are not only similar in spelling but also semantically related (e.g., have similar meanings or connotations). In one example, NLP algorithms may analyze the context in which names appear within the text. The fuzzy matching engine 117 may take into account contextual information when computing similarity scores, and names that occur in similar contexts may receive higher similarity scores. In one example, NLP algorithms may identify named entities, such as names, dates, and addresses, within the text. The fuzzy matching algorithms may leverage NER output to assign higher scores to pairs of names that are recognized as named entities, indicating a higher likelihood of being a match. Overall, incorporating NLP algorithms into the scoring mechanism of fuzzy matching may lead to accurate and contextually aware similarity scores.

Following the extraction of text from a plurality of documents (by the document processing module 115) and the association of the extracted text with relevant entities (by the fuzzy matching engine 117), the storage module 119 may store this structured data in a systematic and accessible manner in the database 111. In one instance, the storage module 119 may organize and manage the extracted text and associated metadata in a structured format for facilitating efficient retrieval of the document data (e.g., for downstream machine-learning processes). In one instance, the storage module 119 may interface with databases, file systems, or cloud storage solutions for seamless integration with other components of the document processing workflows. In one instance, the storage module 119 may provide indexing, filtering, and search capabilities for fast and efficient retrieval of document data based on various criteria, such as document content, metadata, or associated entities. For example, the analysis platform 107 may perform comprehensive searches utilizing the indexed data, and the results may be further refined using advanced filtering options. The filters may include document metadata, date ranges, and specific content attributes, facilitating precise and targeted searches. In one instance, the storage module 119 may implement security measures (e.g., tokenization or encryption of the stored data) and access control mechanisms (e.g., dual verification mechanisms) to protect sensitive data from unauthorized access or tampering. By servicing as a centralized repository for processed document data, the storage module 119 may facilitate training, validation, and deployment of the machine-learning model.

In one embodiment, the machine-learning module 121 may be configured for supervised machine-learning that utilizes training data, e.g., training data 312 illustrated in the training flow chart 300, for training a machine-learning model configured for understanding the semantic context of the extracted text for nuanced matching decisions. The machine-learning module 121 may perform model training using training data, e.g., data from other modules, that contains input and correct output, to allow the model to learn over time. The training may be performed based on the deviation of a processed result from a documented result when the inputs are fed into the machine-learning model, e.g., an algorithm measures its accuracy through the loss function, adjusting until the error has been sufficiently minimized. In one example, the labeled dataset may serve as the foundation for training the machine-learning model, the machine-learning model may analyze the input features and corresponding labels to identify patterns and relationships. By leveraging the labeled dataset, the machine-learning model may iteratively adjust its parameters and optimize its predictive capabilities to develop an accurate algorithm for matching extracted texts.

In one instance, the machine-learning module 121 may randomize the order of the training data, visualize the training data to identify relevant relationships between different variables, identify any data imbalances, and/or split the training data into two parts, where one part may be for training a model and the other part may be for validating the trained model, de-duplicating, normalizing, correcting errors in the training data, and so on. The machine-learning module 121 may implement various machine-learning techniques, e.g., deep-learning algorithms, knowledge graphs, association rule learning, neural networks (e.g., recurrent neural networks, graph convolutional neural networks, deep neural networks), inductive programming logic, support vector machines, Bayesian models, Gradient boosted machines (GBM), LightGBM (LGBM), Xtra tree classifier, etc.

In one example, the machine-learning module 121 may employ one or more pattern recognition algorithms to identify similarities and patterns within the extracted texts for matching entities even in the presence of variations, misspellings, and formatting inconsistencies. In one example, the machine-learning module 121 may utilize semantic analysis techniques to interpret the meaning and context of extracted text for facilitating the precise matching of texts to relevant entities, such as claim participants. In one example, the machine-learning module 121 may implement unsupervised learning approaches (e.g., clustering and anomaly detection) for uncovering hidden structures and anomalies in the data and/or for facilitating exploratory analysis and data-driven decision-making. Through adaptive learning mechanisms, the machine-learning module 121 may continuously improve text-matching capabilities over time, adapting to new data patterns, and evolving document processing requirements.

In one instance, the user interface module 123 may employ various application programming interfaces (APIs) or other function calls corresponding to the application 103 on the user device 101, thus enabling customizable dashboards, interactive visualization tools, and real-time feedback. The user interface module 123 may offer a visually engaging interface that enables users to initiate document processing workflows, monitor progress, and review results seamlessly. In one example, the user interface module 123 may enable a presentation of a graphical user interface (GUI) in the user device 101 that may facilitate the uploading of documents by the users. In one example, the user interface module 123 may enable a presentation of a GUI in the user device 101 that may facilitate the visualization of extracted texts with similarity scores. In one instance, the user interface module 123 may implement responsive design principles to ensure compatibility across a plurality of user devices.

In one example, the user interface module 123 may generate a presentation 125 in the user device 101 that may summarize the key findings, such as extracted names and their similarity scores. It is understood that the user interface module 123 may generate any type of presentation in the user device 101. In one example, the presentation 125 may include a comprehensive view of the document(s) with highlighted extracted texts and the corresponding matches, with notes or annotations indicating the matched participants and related information. In one example, the presentation 125 may list all the extracted entities in a tabular format, along with their corresponding matches and similarity scores. The presentation 125 may allow users to interactively filter and sort the extracted and matched data based on various criteria, such as similarity scores or entity types. The presentation 125 may include hyperlinks that users may click to navigate to specific sections of the document or related documents. In one example, the presentation 125 may provide a side-by-side comparison of the original documents alongside the extracted text and matched datasets for direct comparison. In one example, the presentation 125 may provide real-time alerts to the user about newly matched entities or important updates in the document processing.

The above presented modules and components of the analysis platform 107 may be implemented in hardware, firmware, software, or a combination thereof. Though depicted as a separate entity in FIG. 1, it is contemplated that the analysis platform 107 may be implemented for direct operation by the respective user device 101. As such, the analysis platform 107 may generate direct signal inputs by way of the operating system of the user device 101. In another instance, one or more of the modules 113-123 may be implemented for operation by the respective user devices, as the analysis platform 107. The various executions presented herein contemplate any and all arrangements and models.

In one instance, the database 111 may be any type of database, such as relational, hierarchical, object-oriented, and/or the like, wherein data are organized in any suitable manner, including data tables or lookup tables. In one instance, the database 111 may access or store content associated with the users, the user device 101, and the analysis platform 107, and may manage multiple types of information that provide means for aiding in the content provisioning and sharing process. In one example, the database 111 may store various information related to the users (e.g., claims data, invoice data, image data, etc.). It is understood that any other suitable data may be included in the database 111. In another instance, the database 111 may include a machine-learning based training database with a pre-defined mapping. The pre-defined mapping may define a relationship between various input parameters and output parameters based on various statistical methods. The training database may include a dataset that includes data collections that are not subject-specific, e.g., data collections based on population-wide observations, local, regional or super-regional observations, and the like. The training database may be routinely updated and/or supplemented based on machine-learning methods.

By way of example, the user device 101, the analysis platform 107, and database 111 may communicate with each other and other components of the communication network using well known, new or still developing protocols. In this context, a protocol may include a set of rules defining how the network nodes within the communication network interact with each other based on information sent over the communication links. The protocols are effective at different layers of operations within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header, and a transport (layer 4) header, and various application (layer 5, layer 6 and layer 7) headers as defined by the OSI Reference Model.

### Exemplary Document Processing Flowchart

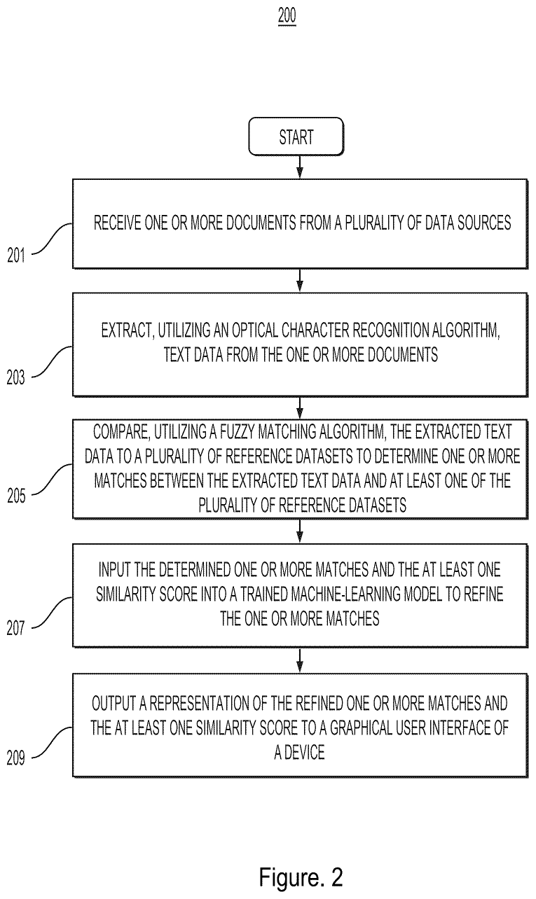

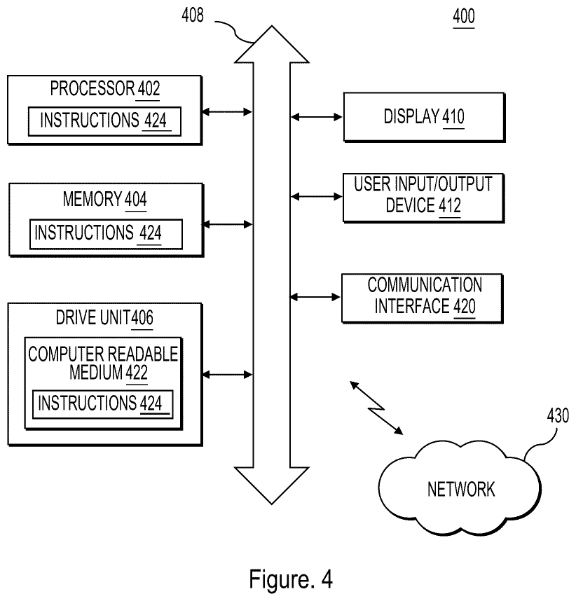

FIG. 2 is an exemplary flowchart of a computer-implemented or computer-based process for determining matches for extracted text data based on one or more similarity score(s). In one instance, the analysis platform 107 and/or any of the modules 113-123 may perform one or more portions of the process 200 and are implemented using, for instance, a chip set including a processor (e.g., processor 402) and a memory (e.g., memory 404) as shown in FIG. 4. As such, the analysis platform 107 and/or any of modules 113-123 may be configured to facilitate accomplishing various parts of the process 200, as well as accomplishing embodiments of other processes described herein in conjunction with other components of the system 100. Although the process 200 is illustrated and described as a sequence of actions, operations, and/or functionality, it is contemplated that various embodiments of the process 200 may be performed in any order or combination and need not include all of the illustrated actions, operations, and/or functionality.

In block 201, the analysis platform 107 may receive document(s) from a plurality of data sources (e.g., external data sources 109). The received document(s) may include insurance documents (e.g., insurance claims, insurance coverage, etc.), financial documents (e.g., invoices, receipts, claims), legal documents (e.g., contracts, deeds), and the like.

In block 203, the analysis platform 107 may extract, utilizing an extraction algorithm (e.g., an OCR algorithm), text data from the document(s). In one instance, the analysis platform 107 may process, utilizing the OCR algorithm, the text data for (i) identifying and segmenting text regions in the document(s), (ii) recognizing characters within the segmented text regions for extraction, and/or (iii) generating a digital representation of the extracted text data in a machine-readable format. In one example, the OCR technology may process the text data by converting the scanned or digital image of a document into a binary format, and the binary image may be analyzed to identify distinct regions that contain text. The OCR technology may segment these identified text regions into smaller components (e.g., lines, words, or characters) for accurately interpreting the structure and layout of the document, and converting the visual text into machine-readable text data.

In block 205, the analysis platform 107 may compare, utilizing a matching algorithm (e.g., fuzzy matching algorithm), the extracted text data to a plurality of reference datasets to determine matches between the extracted text data and at least one of the plurality of reference datasets. In one example, the plurality of reference datasets may serve as authoritative sources for validating extracted text from documents. Such reference datasets may be retrieved from various internal sources (e.g., customer relationship management (CRM) systems, claim management systems, EHR systems, etc.) and external sources (e.g., third-party databases, government databases, industry-standard databases, etc.) relevant to an organization's operations. In one example, the reference datasets may include (i) policyholder datasets which may contain detailed information about insured individuals, such as name, address, and policy numbers; (ii) provider databases which may list the healthcare providers, their contact details, and specialties; (iii) historical claim databases that may record past claims and their outcomes; and/or (iv) standard procedural codes databases that may detail medical procedures and their descriptions. It should be understood that the reference datasets may include a variety of relevant datasets for verifying and processing data. In one example, the reference entities may correspond to specific data points (e.g., a particular policyholder) within these comprehensive datasets. Each reference entity may serve as an element for matching and verifying extracted data from the documents. By comparing the extracted text against the plurality of reference datasets, the analysis platform 107 may verify the accuracy of the extracted text, resolve ambiguities, and ensure that the extracted text corresponds correctly to reference entities.

In one instance, one or more matches may be based on similarity score(s). The analysis platform 107 may calculate, utilizing the fuzzy matching algorithm, the similarity score(s) for the extracted text data based on one or more factors (e.g., an edit distance, a token-based similarity algorithm, or a contextual relevance). In one instance, the edit distance may measure a minimum number of single-character edits (e.g., insertions, deletions, or substitutions) for transforming the extracted text data into at least one of the plurality of reference datasets. In one instance, the token-based similarity algorithm may measure a degree of similarity between the extracted text data and at least one of the plurality of reference datasets. In one example, if the extracted text includes the phrase “Nick A. Jones” and the reference data includes “Nick Jones,” the token-based similarity algorithm may recognize the high degree of overlap between the tokens “Nick” and “Jones”, even though there is an additional “A.” The algorithm may calculate similarity score(s) based on the proportion of matching tokens and their positions within the texts. The degree of similarity may include one or more common substrings or a phonetic resemblance. In one instance, the analysis platform 107 may process the extracted text data by utilizing NLP algorithm, and may determine a semantic meaning or a contextual alignment between the extracted text data and the plurality of reference datasets.

The analysis platform 107 may determine, utilizing the fuzzy matching algorithm, one or more matches by evaluating the similarity score(s) against a pre-determined threshold (e.g., a minimum acceptable similarity level for the matches). In one instance, the analysis platform 107 may calculate, utilizing the fuzzy matching algorithm, one or more similarity score(s) by aggregating the one or more factors (e.g., an edit distance, a token-based similarity algorithm, or a contextual relevance) into a composite similarity score for each comparison. The analysis platform 107 may select the text data from the plurality of reference datasets upon determining the composite similarity score exceeds the pre-determined threshold. In one example, the composite similarity score may be a calculated metric for quantifying the overall similarity between an extracted text and the reference datasets by combining multiple similarity assessment factors (e.g., an edit distance, a token-based similarity algorithm, or a contextual relevance) into a single score. By aggregating these various factors, the composite similarity score may provide a comprehensive evaluation of how closely the extracted text matches the reference dataset, thereby facilitating a more accurate and reliable matching process. For example, the extracted text “Doe Smith” may be compared against a reference dataset containing the name “Doe A. Smith”. The analysis platform 107 may handle spelling variations, ensuring that minor discrepancies do not hinder the matching process. For example, when searching for the name “Daniel,” the analysis platform 107 may recognize and match similar variations such as “Danyel” or “Daneiel.” By accommodating common misspellings or variations in spellings, the accuracy of the matching may be enhanced. The analysis platform 107 may perform matching based on the last name, and such a feature may be useful in scenarios where the first name is missing, abbreviated, or inconsistently recorded. By focusing on the last name, the analysis platform 107 may ensure that relevant documents are not overlooked due to incomplete or partial name entries. The analysis platform 107 may also handle different combinations of first and last names to facilitate accurate matching even when the order of names is reversed. For example, the extracted text “Smith Doe” may be compared against the reference dataset containing the name “Doe A. Smith”. By recognizing and correctly matching such variations, the analysis platform 107 may handle cases where names are recorded inconsistently, such as “Smith Doe” instead of “Doe Smith”. The various similarity metrics, such as edit distance, token-based similarity algorithm, and contextual relevance may be utilized to generate a composite similarity score of 0.95. If the threshold for considering a match is set at 0.90, the composite similarity score of 0.95 exceeds this threshold, indicating a high degree of similarity between the extracted text and the reference data, despite a minor difference in spelling.

In one instance, the fuzzy matching algorithm may perform partial matching by identifying and scoring individual segments of the extracted text data against the plurality of reference datasets. This may facilitate the identification of relevant matches between the segments and the reference datasets, even when the entire text may not perfectly align. In one instance, the fuzzy matching algorithm may utilize similarity metric(s) (e.g., a Levenshtein distance or a Jaccard similarity) to compare the extracted text data to the plurality of reference datasets. In one instance, the fuzzy matching algorithm may utilize phonetic algorithm(s) (e.g., Soundex algorithm or a Metaphone algorithm) for handling variation(s) in spelling or pronunciations of the extracted text data and the plurality of reference datasets.

In block 207, the analysis platform 107 may input the determined matches and the similarity score(s) into a trained machine-learning model to refine one or more matches and/or to validate a similarity assessment. In one example, after a fuzzy matching algorithm may identify one or more matches, the trained machine-learning model may analyze these matches to detect patterns and discrepancies, and may adjust the algorithm's parameters to improve precision. The trained machine-learning model may assess similarity score(s) by incorporating additional contextual and semantic information to ensure that the matches are not only statistically similar, but also contextually relevant. In one example, the trained machine-learning model may validate the similarity assessments by comparing them against historical data and known outcomes, and/or identifying and correcting errors or false positives. This iterative learning process may allow the trained machine-learning model to refine the criteria for matches, adapt to varying document structure and content, and improve the reliability and accuracy of text matching over time. As the trained machine-learning model iteratively refines the matching criteria, it may enhance the accuracy and reliability of the one or more matches (e.g., the actual matches), reducing false positives and false negatives. For example, when the trained machine-learning model refines the matching criteria, the matches may be updated (e.g., refined) to reflect the matches that correspond to the matching criteria.

In one instance, the analysis platform 107 may assess, utilizing the trained machine-learning model, the determined matches and the similarity score(s) to adjust one or more parameters of the similarity assessment to improve matching accuracy. In one example, the parameters may include weights assigned to different similarity metrics (e.g., edit distance, the token similarity, or contextual relevance), and determine their influence on the overall similarity score(s). The trained machine-learning model may also tune thresholds for determining a match and reducing false positives and false negatives. By dynamically adjusting these parameters based on feedback and new data, the trained machine-learning model may improve its accuracy in matching and validating the extracted texts. In one example, the feedback may include using performance metrics derived from a validation dataset or cross-validation technique. During the training phase, the performance of the machine-learning model may be evaluated based on predefined metrics such as accuracy, precision, or recall. The feedback may then be obtained from these performance metrics. Based on this feedback, the parameters of the machine-learning model may be dynamically adjusted to optimize performance.

In block 209, the analysis platform 107 may output a representation of the refined matches and the similarity score(s) in a graphical user interface of the user device 101. In one example, the user interface module 123 may display the extracted text alongside the corresponding matched entries from the reference dataset, highlighting areas of high similarity with visual cues, such as color coding or underlining. The similarity scores for each match may also be shown to convey the strength of the match. By displaying the similarity score alongside each match, users may assess the degree of similarity between the extracted text and the reference data. A high similarity score may indicate a strong correspondence between the two, suggesting a strong match, while a lower score may indicate potential discrepancies that may require further review. The users may prioritize and focus their attention on matches with higher scores. In one example, interactive elements in the graphical user interface may allow the users to filter, sort, and navigate through the matches for detailed inspection of the individual entries and their associated scores.

Although FIG. 2 shows example blocks of exemplary computer-implemented or computer-based process 200, in some implementations, the exemplary computer-implemented or computer-based process 200 may include additional blocks, fewer blocks, different blocks, or differently arranged blocks than those depicted in FIG. 2. Additionally, or alternatively, two or more of the blocks of the exemplary computer-implemented or computer-based process 200 may be performed in parallel.

### Exemplary Machine-Learning Techniques

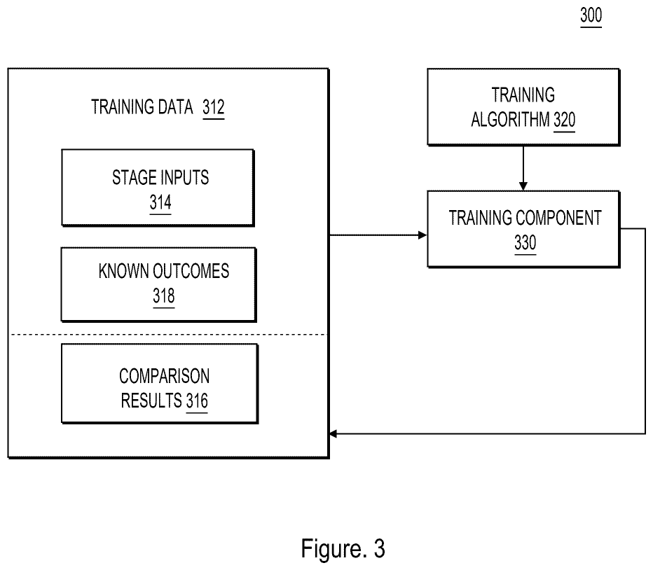

One or more implementations disclosed herein include and/or may be implemented using a machine-learning model. For example, one or more of the modules of the analysis platform 107 may be implemented using a machine-learning model and/or may be used to train the machine-learning model. A given machine-learning model may be trained using the training flow chart 300 of FIG. 3. Training data 312 may include one or more of stage inputs 314 and known outcomes 318 related to the machine-learning model to be trained. The stage inputs 314 may be from any applicable source including text, visual representations, data, values, comparisons, stage outputs, e.g., one or more outputs from one or more actions or operations from FIG. 2. The known outcomes 318 may be included for the machine-learning models generated based upon supervised or semi-supervised training. An unsupervised machine-learning model may not be trained using known outcomes 318. Known outcomes 318 may include known or desired outputs for future inputs similar to, or in the same category as, stage inputs 314 that do not have corresponding known outputs.

The training data 312 and a training algorithm 320, e.g., one or more of the modules implemented using the machine-learning model and/or may be used to train the machine-learning model, may be provided to a training component 330 that may apply the training data 312 to the training algorithm 320 to generate the machine-learning model. According to an implementation, the training component 330 may be provided comparison results 316 that compare a previous output of the corresponding machine-learning model to apply the previous result to re-train the machine-learning model. The comparison results 316 may be used by training component 330 to update the corresponding machine-learning model. The training algorithm 320 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, models specifically discussed in the present disclosure, or the like.

The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

### Exemplary Computing Environment

In general, any process or operation discussed in this disclosure is understood to be computer-implementable, such as the processes illustrated in FIG. 2, and may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

FIG. 4 illustrates an implementation of a computer system that may execute techniques presented herein. The computer system 400 can include a set of instructions that can be executed to cause the computer system 400 to perform any one or more of the methods or computer based functions disclosed herein. The computer system 400 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 400 may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 400 may be implemented using electronic devices that provide voice, video, or data communication. Further, while the computer system 400 is illustrated as a single system, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 400 may further include a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the computer system 400 may include an input/output device 412 configured to allow a user to interact with any of the components of the computer system 400. The input/output device 412 may be a number pad, a keyboard, or a cursor control device, such as a mouse, or a joystick, touch screen display, remote control, or any other device operative to interact with the computer system 400.

The computer system 400 may also or alternatively include drive unit 406 implemented as a disk or optical drive. The drive unit 406 may include a computer-readable medium 422 in which one or more sets of instructions 424, e.g., software, can be embedded. Further, instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, computer-readable medium 422 includes the set of instructions 424 or receives and executes the set of instructions 424 responsive to a propagated signal so that a device connected to network 430 can communicate voice, video, audio, images, or any other data over the network 430. Further, the set of instructions 424 may be transmitted or received over the network 430 via communication port or interface 420, and/or using bus 408. The communication port or interface 420 may be a part of the processor 402 or may be a separate component. The communication port or interface 420 may be created in software or may be a physical connection in hardware. The communication port or interface 420 may be configured to connect with a network 430, external media, the display 410, or any other components in computer system 400, or combinations thereof. The connection with the network 430 may be a physical connection, such as a wired Ethernet connection or may be established wirelessly as discussed below. Likewise, the additional connections with other components of the computer system 400 may be physical connections or may be established wirelessly. The network 430 may alternatively be directly connected to the bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 400 may be connected to network 430. The network 430 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 430 may include wide area networks (WAN), such as the Internet, local area networks (LAN), campus area networks, metropolitan area networks, a direct connection such as through a Universal Serial Bus (USB) port, or any other networks that may allow for data communication.

The network 430 may be configured to couple one computing device to another computing device to enable communication of data between the devices. The network 430 may generally be enabled to employ any form of machine-readable media for communicating information from one device to another. The network 430 may include communication methods by which information may travel between computing devices.

The network 430 may be divided into sub-networks. The sub-networks may allow access to all of the other components connected thereto or the sub-networks may restrict access between the components. The network 430 may be regarded as a public or private network connection and may include, for example, a virtual private network or an encryption or other security mechanism employed over the public Internet, or the like.

### Exemplary Embodiments

A computer-implemented method for matching extracted text data based on similarity score(s) may be provided. The computer-implemented method may be performed by one or more local or remote processors of a computing system in communication with one or more local or remote data sources. The computer-implemented method may include (1) receiving, by one or more processors, one or more documents from a plurality of data sources; (2) extracting, by the one or more processors utilizing an optical character recognition algorithm, text data from the one or more documents; (3) comparing, by the one or more processors utilizing a fuzzy matching algorithm, the extracted text data to a plurality of reference datasets to determine one or more matches between the extracted text data and at least one of the plurality of reference datasets, wherein the one or more matches are based on at least one similarity score; (4) inputting, by the one or more processors, the determined one or more matches and the at least one similarity score into a trained machine-learning model to refine the one or more matches; and (5) outputting, by the one or more processors, a representation of the refined one or more matches and the at least one similarity score to a graphical user interface of a device. The method may include additional, less, or alternate functionality, including that discussed elsewhere herein.

In certain aspects, extracting the text data from the one or more documents may include (1) processing, by the one or more processors utilizing the optical character recognition algorithm, the text data for identifying and segmenting text regions in the one or more documents; (2) recognizing, by the one or more processors utilizing the optical character recognition algorithm, characters within the segmented text regions for extraction; and (3) generating, by the one or more processors utilizing the optical character recognition algorithm, a digital representation of the extracted text data in a machine-readable format.

In certain aspects, comparing the extracted text data to the plurality of reference datasets for determining the one or more matches may include (1) calculating, by the one or more processors utilizing the fuzzy matching algorithm, the at least one similarity score for the extracted text data based on one or more factors, wherein the one or more factors include an edit distance, a token-based similarity algorithm, or a contextual relevance; and (2) determining, by the one or more processors utilizing the fuzzy matching algorithm, the one or more matches by evaluating the at least one similarity score against a pre-determined threshold, wherein the pre-determined threshold indicates a minimum acceptable similarity level for the one or more matches.

For instance, the edit distance may measure a minimum number of single-character edits for transforming the extracted text data into at least one of the plurality of reference datasets. For instance, the token-based similarity algorithm may measure a degree of similarity between extracted text data and at least one of the plurality of reference datasets, wherein the degree of similarity includes one or more common substrings or a phonetic resemblance.

In certain aspects, determining contextual relevance may include (1) processing, by the one or more processors, the extracted text data by utilizing a natural language processing (NLP) algorithm; and (2) determining, by the one or more processors, a semantic meaning or a contextual alignment between the extracted text data and the plurality of reference datasets.

In certain aspects, determining the one or more matches by evaluating the at least one similarity score against the pre-determined threshold may include (1) calculating, by the one or more processors utilizing the fuzzy matching algorithm, the at least one similarity score by aggregating the one or more factors into a composite similarity score for each comparison; and (2) selecting, by the one or more processors utilizing the fuzzy matching algorithm, the text data from the plurality of reference datasets upon determining the composite similarity score exceeds the pre-determined threshold.

For instance, the fuzzy matching algorithm may perform partial matching by identifying and scoring individual segments of the extracted text data against the plurality of reference datasets. For instance, the fuzzy matching algorithm may utilize one or more similarity metrics to compare the extracted text data to the plurality of reference datasets, wherein the one or more similarity metrics include a Levenshtein distance or a Jaccard similarity. For instance, the fuzzy matching algorithm may utilize one or more phonetic algorithms for handling one or more variations in spelling or pronunciations of the extracted text data and the plurality of reference datasets, wherein the one or more phonetic algorithms include a Soundex algorithm or a Metaphone algorithm.

A system for matching extracted text data based on similarity score(s) may be provided. The system includes one or more processors of a computing system; and at least one non-transitory computer readable medium storing instructions which, when executed by the one or more processors, cause the one or more processors to perform operations including (1) receiving one or more documents from a plurality of data sources; (2) extracting, utilizing an extraction technology, text data from the one or more documents; (3) comparing, utilizing a matching algorithm, the extracted text data to a plurality of reference datasets to determine one or more matches between the extracted text data and at least one of the plurality of reference datasets, wherein the one or more matches are based on at least one similarity score; (4) inputting the determined one or more matches and the at least one similarity score into a trained machine-learning model to validate a similarity assessment; and (5) outputting a representation of the one or more matches and the at least one similarity score to a graphical user interface of a device. The system may include additional, less, or alternate functionality, including that discussed elsewhere herein.

In certain aspects, inputting the determined one or more matches and the at least one similarity score into the trained machine-learning model to validate the similarity assessment may include (1) analyzing, utilizing the trained machine-learning model, the determined one or more matches and the at least one similarity score for adjusting one or more parameters of the similarity assessment to improve a matching accuracy.

In certain aspects, the extraction technology may include an optical character recognition algorithm, and extracting the text data from the one or more documents may include (1) processing, utilizing the optical character recognition algorithm, the text data for identifying and segmenting text regions in the one or more documents; (2) recognizing, utilizing the optical character recognition algorithm, characters within the segmented text regions for extraction; and (3) generating, utilizing the optical character recognition algorithm, a digital representation of the extracted text data in a machine-readable format.

In certain aspects, the matching algorithm may include a fuzzy matching algorithm, and comparing the extracted text data to the plurality of reference datasets for determining the one or more matches may include (1) calculating, utilizing the fuzzy matching algorithm, the at least one similarity score for the extracted text data based on one or more factors, wherein the one or more factors include an edit distance, a token-based similarity algorithm, or a contextual relevance; and (2) determining, utilizing the fuzzy matching algorithm, the one or more matches by evaluating the at least one similarity score against a pre-determined threshold, wherein the pre-determined threshold indicates a minimum acceptable similarity level for the one or more matches.

In certain aspects, determining the one or more matches by evaluating the at least one similarity score against the pre-determined threshold may include (1) calculating, utilizing the fuzzy matching algorithm, the at least one similarity score by aggregating the one or more factors into a composite similarity score for each comparison; and (2) selecting, utilizing the fuzzy matching algorithm, the text data from the plurality of reference datasets upon determining the composite similarity score exceeds the pre-determined threshold.

For instance, the fuzzy matching algorithm may utilize one or more similarity metrics to compare the extracted text data to the plurality of reference datasets, and the one or more similarity metrics include a Levenshtein distance or a Jaccard similarity.

For instance, the fuzzy matching algorithm may utilize one or more phonetic algorithms for handling one or more variations in spelling or pronunciations of the extracted text data and the plurality of reference datasets, wherein the one or more phonetic algorithms include a Soundex algorithm or a Metaphone algorithm.

A non-transitory computer readable medium for matching extracted text data based on similarity score(s) may be provided. The non-transitory computer readable medium storing instructions which, when executed by one or more processors of a computing system, cause the one or more processors to perform operations including (1) receiving one or more documents from a plurality of data sources; (2) extracting, utilizing an optical character recognition algorithm, text data from the one or more documents; (3) comparing, utilizing a fuzzy matching algorithm, the extracted text data to a plurality of reference datasets to determine one or more matches between the extracted text data and at least one of the plurality of reference datasets, wherein the one or more matches are based on at least one similarity score; (4) inputting the determined one or more matches and the at least one similarity score into a trained machine-learning model to refine the one or more matches; and (5) outputting a representation of the refined one or more matches and the at least one similarity score to a graphical user interface of a device. The non-transitory computer readable medium may include additional, less, or alternate functionality, including that discussed elsewhere herein.

In certain aspects, extracting the text data from the one or more documents may include (1) processing, utilizing the optical character recognition algorithm, the text data for identifying and segmenting text regions in the one or more documents; (2) recognizing, utilizing the optical character recognition algorithm, characters within the segmented text regions for extraction; and (3) generating, utilizing the optical character recognition algorithm, a digital representation of the extracted text data in a machine-readable format.

In certain aspects, comparing the extracted text data to the plurality of reference datasets for determining the one or more matches may include (1) calculating, utilizing the fuzzy matching algorithm, the at least one similarity score for the extracted text data based on one or more factors, wherein the one or more factors include an edit distance, a token-based similarity algorithm, or a contextual relevance; and (2) determining, utilizing the fuzzy matching algorithm, the one or more matches by evaluating the at least one similarity score against a pre-determined threshold, wherein the pre-determined threshold indicates a minimum acceptable similarity level for the one or more matches.

### Additional Considerations

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method comprising:
receiving, by one or more processors, one or more documents from a plurality of data sources;
extracting, by the one or more processors utilizing an optical character recognition algorithm, text data from the one or more documents;
comparing, by the one or more processors utilizing a fuzzy matching algorithm, the extracted text data to a plurality of reference datasets to determine one or more matches between the extracted text data and at least one of the plurality of reference datasets, wherein the one or more matches are based on at least one similarity score;
inputting, by the one or more processors, the determined one or more matches and the at least one similarity score into a trained machine-learning model to refine the one or more matches; and
outputting, by the one or more processors, a representation of the refined one or more matches and the at least one similarity score to a graphical user interface of a device.

2. The computer-implemented method of claim 1, wherein extracting the text data from the one or more documents comprises:
processing, by the one or more processors utilizing the optical character recognition algorithm, the text data for identifying and segmenting text regions in the one or more documents;
recognizing, by the one or more processors utilizing the optical character recognition algorithm, characters within the segmented text regions for extraction; and
generating, by the one or more processors utilizing the optical character recognition algorithm, a digital representation of the extracted text data in a machine-readable format.

3. The computer-implemented method of claim 1, wherein comparing the extracted text data to the plurality of reference datasets for determining the one or more matches comprises:
calculating, by the one or more processors utilizing the fuzzy matching algorithm, the at least one similarity score for the extracted text data based on one or more factors, wherein the one or more factors include an edit distance, a token-based similarity algorithm, or a contextual relevance; and
determining, by the one or more processors utilizing the fuzzy matching algorithm, the one or more matches by evaluating the at least one similarity score against a pre-determined threshold, wherein the pre-determined threshold indicates a minimum acceptable similarity level for the one or more matches.

4. The computer-implemented method of claim 3, wherein the edit distance measures a minimum number of single-character edits for transforming the extracted text data into at least one of the plurality of reference datasets.

5. The computer-implemented method of claim 3, wherein the token-based similarity algorithm measures a degree of similarity between extracted text data and at least one of the plurality of reference datasets, and wherein the degree of similarity includes one or more common substrings or a phonetic resemblance.

6. The computer-implemented method of claim 3, further comprising:
processing, by the one or more processors, the extracted text data by utilizing a natural language processing (NLP) algorithm; and
determining, by the one or more processors, a semantic meaning or a contextual alignment between the extracted text data and the plurality of reference datasets.

7. The computer-implemented method of claim 3, wherein determining the one or more matches by evaluating the at least one similarity score against the pre-determined threshold comprises:
calculating, by the one or more processors utilizing the fuzzy matching algorithm, the at least one similarity score by aggregating the one or more factors into a composite similarity score for each comparison; and
selecting, by the one or more processors utilizing the fuzzy matching algorithm, the text data from the plurality of reference datasets upon determining the composite similarity score exceeds the pre-determined threshold.

8. The computer-implemented method of claim 1, wherein the fuzzy matching algorithm performs partial matching by identifying and scoring individual segments of the extracted text data against the plurality of reference datasets.

9. The computer-implemented method of claim 1, wherein the fuzzy matching algorithm utilizes one or more similarity metrics to compare the extracted text data to the plurality of reference datasets, and wherein the one or more similarity metrics include a Levenshtein distance or a Jaccard similarity.

10. The computer-implemented method of claim 1, wherein the fuzzy matching algorithm utilizes one or more phonetic algorithms for handling one or more variations in spelling or pronunciations of the extracted text data and the plurality of reference datasets, and wherein the one or more phonetic algorithms include a Soundex algorithm or a Metaphone algorithm.

11. A system comprising:
one or more processors of a computing system; and
at least one non-transitory computer readable medium storing instructions which, when executed by the one or more processors, cause the one or more processors to perform operations comprising:
receiving one or more documents from a plurality of data sources;
extracting, utilizing an extraction technology, text data from the one or more documents;
comparing, utilizing a matching algorithm, the extracted text data to a plurality of reference datasets to determine one or more matches between the extracted text data and at least one of the plurality of reference datasets, wherein the one or more matches are based on at least one similarity score;
inputting the determined one or more matches and the at least one similarity score into a trained machine-learning model to validate a similarity assessment; and
outputting a representation of the one or more matches and the at least one similarity score to a graphical user interface of a device.

12. The system of claim 11, wherein inputting the determined one or more matches and the at least one similarity score into the trained machine-learning model to validate the similarity assessment comprises:
analyzing, utilizing the trained machine-learning model, the determined one or more matches and the at least one similarity score for adjusting one or more parameters of the similarity assessment to improve a matching accuracy.

13. The system of claim 11, wherein the extraction technology includes an optical character recognition algorithm, and wherein extracting the text data from the one or more documents comprises:
processing, utilizing the optical character recognition algorithm, the text data for identifying and segmenting text regions in the one or more documents;
recognizing, utilizing the optical character recognition algorithm, characters within the segmented text regions for extraction; and
generating, utilizing the optical character recognition algorithm, a digital representation of the extracted text data in a machine-readable format.

14. The system of claim 11, wherein the matching algorithm includes a fuzzy matching algorithm, and wherein comparing the extracted text data to the plurality of reference datasets for determining the one or more matches comprises:
calculating, utilizing the fuzzy matching algorithm, the at least one similarity score for the extracted text data based on one or more factors, wherein the one or more factors include an edit distance, a token-based similarity algorithm, or a contextual relevance; and
determining, utilizing the fuzzy matching algorithm, the one or more matches by evaluating the at least one similarity score against a pre-determined threshold, wherein the pre-determined threshold indicates a minimum acceptable similarity level for the one or more matches.

15. The system of claim 14, wherein determining the one or more matches by evaluating the at least one similarity score against the pre-determined threshold comprises:
calculating, utilizing the fuzzy matching algorithm, the at least one similarity score by aggregating the one or more factors into a composite similarity score for each comparison; and
selecting, utilizing the fuzzy matching algorithm, the text data from the plurality of reference datasets upon determining the composite similarity score exceeds the pre-determined threshold.

16. The system of claim 14, wherein the fuzzy matching algorithm utilizes one or more similarity metrics to compare the extracted text data to the plurality of reference datasets, and wherein the one or more similarity metrics include a Levenshtein distance or a Jaccard similarity.

17. The system of claim 14, wherein the fuzzy matching algorithm utilizes one or more phonetic algorithms for handling one or more variations in spelling or pronunciations of the extracted text data and the plurality of reference datasets, and wherein the one or more phonetic algorithms include a Soundex algorithm or a Metaphone algorithm.

18. A non-transitory computer readable medium, the non-transitory computer readable medium storing instructions which, when executed by one or more processors of a computing system, cause the one or more processors to perform operations comprising:
receiving one or more documents from a plurality of data sources;
extracting, utilizing an optical character recognition algorithm, text data from the one or more documents;
comparing, utilizing a fuzzy matching algorithm, the extracted text data to a plurality of reference datasets to determine one or more matches between the extracted text data and at least one of the plurality of reference datasets, wherein the one or more matches are based on at least one similarity score;
inputting the determined one or more matches and the at least one similarity score into a trained machine-learning model to refine the one or more matches; and
outputting a representation of the refined one or more matches and the at least one similarity score to a graphical user interface of a device.

19. The non-transitory computer readable medium of claim 18, wherein extracting the text data from the one or more documents comprises:
processing, utilizing the optical character recognition algorithm, the text data for identifying and segmenting text regions in the one or more documents;
recognizing, utilizing the optical character recognition algorithm, characters within the segmented text regions for extraction; and
generating, utilizing the optical character recognition algorithm, a digital representation of the extracted text data in a machine-readable format.

20. The non-transitory computer readable medium of claim 18, wherein comparing the extracted text data to the plurality of reference datasets for determining the one or more matches comprises:
calculating, utilizing the fuzzy matching algorithm, the at least one similarity score for the extracted text data based on one or more factors, wherein the one or more factors include an edit distance, a token-based similarity algorithm, or a contextual relevance; and
determining, utilizing the fuzzy matching algorithm, the one or more matches by evaluating the at least one similarity score against a pre-determined threshold, wherein the pre-determined threshold indicates a minimum acceptable similarity level for the one or more matches.
